(19) United States
(12) Patent Application Publication
(10) Pub. No.: US 2001/0030719 A1
(43) Pub. Date: Oct. 18, 2001

(54) Liquid crystal dlsplay and manufacturing method therefor

(75) Inventors: Takehisa Yamaguchi, Kikuchi-gun (JP); Takafumi Hashiguchi, Kikuchi-gun (JP); Naoki Nakagawa, Kikuchi-gun (JP); Satoshi Kohtaka, Kikuchi-gun (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: ADVANCED DISPLAY INC., Kikuchi-gun (JP)

(21) Appl. No.: 09/832,892

(22) Filed: Apr. 12, 2001

(30) Foreign Application Priority Data
Apr. 14, 2000 (JP) 2000-114239

(51) Int. Cl. G02F 1/136; G02F 1/1343

(52) U.S. Cl. 349/43

(57) ABSTRACT

The liquid crystal display of the present invention comprising: a gate electrode line formed on an insulating substrate; a source electrode line including a source electrode intersected with said gate electrode line via an insulating film, a thin film transistor located in a vicinity of a portion in which said gate electrode line is intersected with said source electrode line; two drain electrode lines, each including two drain electrodes in said thin film transistor, said drain electrode line being connected with a pixel electrode; wherein said thin film transistor includes said two drain electrode lines located on both sides of said source electrode; said two drain electrodes being formed at a place where each end portion of said two drain electrode lines opposed to said source electrode is superposed with said gate electrode line.

### BACKGROUND OF THE INVENTION

The present invention relates to a liquid crystal display capable of preventing a flicker of a screen, a difference in luminance between divisional exposure regions, thereby obtaining an excellent display quality in a liquid crystal display.

For example, Japanese Unexamined Patent Publication No. 328038/1996 has disclosed a structure of a thin film transistor (hereinafter referred to as a TFT) to be provided as a switching element on each pixel in a conventional active matrix liquid crystal display. As shown in a plan view illustrating one pixel of the conventional active matrix type display device in FIG. 11, a drain electrode is protruded to on only one direction of two thin film transistors or two source electrodes of the two thin film transistors so that an aperture ratio can be enhanced and a change in a overlapping area of a source electrode and a common gate electrode can be eliminated even if a mask of photolithography is shifted during the formation of the thin film transistor (In FIG. 11, the common drain electrode is protruded to only one direction of the two source electrodes). The source electrode in the above-mentioned Japanese Publication indicates an electrode to be connected to a pixel electrode, and is equivalent to a drain electrode according to the present invention.

In the above-mentioned structure, however, it is possible to prevent a difference in luminance between divisional exposure regions (shots) having a parasitic capacitance (hereinafter referred to as Cgd) between a gate electrode and a source electrode (a drain electrode according to the present invention), a source electrode line (a drain electrode line in the present invention) to be connected to a pixel electrode intersects a gate electrode line over the whole region in a direction of a channel length which is opposed to the drain electrode as shown in the conventional art of FIG. 11 so that a value of Cgd is increased. With an increase in the value of Cgd, there arises a problem of flicker on a display screen. As is well known, the flicker is generated because an effective value of a voltage to be applied to a liquid crystal is varied between a frame and the next frame.

When Cgd is increased, a time constant of the gate electrode line is increased. Consequently, a delay is caused after a transition of a gate applied voltage from On (High) to Off (Low) in the direction from a driving side to a distant end of a display surface and so-called rewriting is caused in the vicinity of the distant end, that is, data (drain electrode potential) for a horizontal period next to a predetermined horizontal period are written in the predetermined period. Consequently, a deviation is generated for a predetermined pixel potential. During the transition of the gate applied voltage from On (High) to Off (Low), furthermore, a voltage drop (hereinafter referred to as a feedthrough voltage) of a pixel electrode potential caused by the parasitic capacitance of the TFT is generated. When the feedthrough voltage is increased, a difference in an electric potential between the drain electrode and the source electrode in the TFT is increased. Consequently, the rewriting is caused more easily due to the delay after the transition of the gate applied voltage from On (High) to Off (Low) in the direction from the driving side to the distant end of the display surface.

The feed-through voltage ΔVg is calculated by the following equation:

ΔVg=(Cgd/(Cs+Clc+Cgd))*(Vgh−Vgl)

wherein Cgd represents an overlap capacitance of a gate electrode and a drain electrode of the TFT, Cs represents a storage capacitance, Clc represents a liquid crystal capacitance, and Vgh and Vgl represent a high voltage value and a low voltage value of a gate applied voltage, respectively. As is apparent from the equation, ΔVg greatly depends on the value of Cgd. When the absolute value of Cgd is reduced, the value of ΔVg is also reduced. By the reduction in ΔVg, the rewriting can be suppressed.

For the above-mentioned reason, the conventional structure has an effect that a variation in Cgd between the shots can be suppressed but the feed-through voltage ΔVg is increased because an increase in the value of Cgd, resulting in a problem of easily causing a flicker.

In consideration of the above-mentioned drawback, it is an object of the present invention to suppress a variation in Cgd caused by unevennesses among shots and to prevent a flicker by a reduction in the value of Cgd, thereby obtaining a high display quality.

### SUMMARY OF THE INVENTION

A first aspect of the present invention is directed to a display device comprising:

a gate electrode line including a gate electrode formed on an insulating substrate;

a source electrode line including a source electrode intersected with said gate electrode line via an insulating film;

a thin film transistor located in a vicinity of a portion in which said gate electrode line is intersected with said source electrode line;

two drain electrode lines, each including two drain electrodes in said thin film transistor, said drain electrode line being connected with a pixel electrode;

wherein said thin film transistor includes said two drain electrode lines located on both sides of said source electrode; said two drain electrodes are formed at a place where each end portion of said two drain electrode lines opposed to said source electrode is superposed with said gate electrode line.

It is preferable that wherein an area of a region where said gate electrode line is superposed with one of said two drain electrode lines is substantially identical to an area of a region where said gate line is superposed with the other one of said two drain electrode lines.

It is preferable that a length of a region in a channel lengthwise direction of said thin film transistor where said gate electrode line is superposed with one of said two drain electrodes is substantially identical to a length of a region in a channel lengthwise direction of said thin film transistor where said gate electrode line is superposed with the other one of said two drain electrode lines.

It is preferable that the above-mentioned length of the area in the channel lengthwise direction is such a length as to prevent a current characteristics from degradation in said thin film transistor.

It is preferable that wherein the above-mentioned drain electrode is formed in whole part of one end of the drain electrode line in a channel widthwise direction where the drain electrode line is superposed with the gate electrode line.

It is preferable that the above-mentioned drain electrode is formed at a portion where a part of one end of the drain electrode line in the channel widthwise direction opposed to the source electrode is superposed with the gate electrode line on both sides of the source electrode.

It is preferable that the above-mentioned source electrode line extended to the source electrode from said source electrode line is provided with a semiconductor film situated above the gate electrode line or below the same via an insulating film in reference to the insulating substrate.

It is preferable that the above-mentioned source electrode line extended to the source electrode from the source electrode line is provided with a semiconductor film, the semiconductor film being situated above the part of the source electrode line or below the same in reference to the insulating substrate.

It is preferable that the above-mentioned two drain electrodes opposed to said source electrode on both sides of said source electrode are connected with each other in the region between said two drain electrode lines and said pixel electrodes, said drain electrodes being connected with said pixel electrode by a single part of said drain electrodes.

It is preferable that the above-mentioned drain electrode line is formed of a same film as that of the pixel electrode.

A second aspect of the present invention is directed to a method for manufacturing a liquid crystal display comprising steps of:

forming a gate electrode line pattern on an insulating substrate;

forming a semiconductor film covering said gate electrode line;

depositing a conductive film serving as source/drain electrodes on said insulating film; and

subjecting said deposited conductive film to patterning in such a manner that two drain electrodes are formed in a portion where each end of two drain electrodes opposed to said source electrode is superposed in a channel lengthwise direction with said gate electrode line on both sides of said source electrode.

A third aspect of the present invention is directed to a method for manufacturing a liquid crystal display comprising steps of:

depositing a conductive film on an insulating substrate serving as source/drain electrodes;

subjecting said deposited conductive film to patterning in such a manner that two drain electrodes are formed in a portion where each part of the two drain electrode lines extending in a channel length wise direction is superposed with a gate electrode line, said drain electrode lines being opposed to said source electrode on both side surfaces;

forming a semiconductor film on said source/drain electrodes;

forming an insulating film in such a manner as to cover said semiconductor film; and

forming a gate electrode pattern on said insulating film.

In the method mentioned above, there can be further included a step of forming a pixel electrode pattern connected with said drain electrode, wherein said drain electrode is formed in said step of forming a pixel electrode.

### BRIEF DESCRIPTION OF THE DRAWINGS

The accompanying drawings, which are incorporated in and form a part of the specification, illustrate the preferred embodiments of the present invention and, with the description, explain the principles of the invention. In the drawings:

FIG. 1 is a plan view showing one pixel in an active matrix liquid crystal display according to EMBODIMENT 1 of the present invention;

FIG. 2 is an enlarged view showing a TFT portion of FIG. 1;

FIG. 3 is an explanatory view illustrating a relation between a drain current and a contact length between a drain electrode and a gate electrode in the active matrix liquid crystal display according to EMBODIMENT 1 of the present invention;

FIGS. 4(a) to 4(c) are sectional views taken along a line A-A of the TFT portion of FIG. 2 each illustrating respective manufacturing step;

FIGS. 5(a) to 5(c) are sectional views taken along a line A-A of the TFT portion of FIG. 2 each illustrating respective manufacturing step;

FIG. 6 is an enlarged view showing a TFT portion of the active matrix display according to EMBODIMENT 2 of the present invention;

FIG. 7 is an enlarged view showing a TFT portion of the active matrix display according to EMBODIMENT 3 of the present invention;

FIG. 8 is an enlarged view showing a TFT portion of the active matrix display according to EMBODIMENT 4 of the present invention;

FIG. 9 is an enlarged view showing a TFT portion of the active matrix display according to EMBODIMENT 5 of the present invention;

FIG. 10 is an enlarged view showing a TFT portion of the active matrix display according to EMBODIMENT 6 of the present invention; and

FIG. 11 is a plan view showing one pixel in a conventional active matrix liquid crystal display.

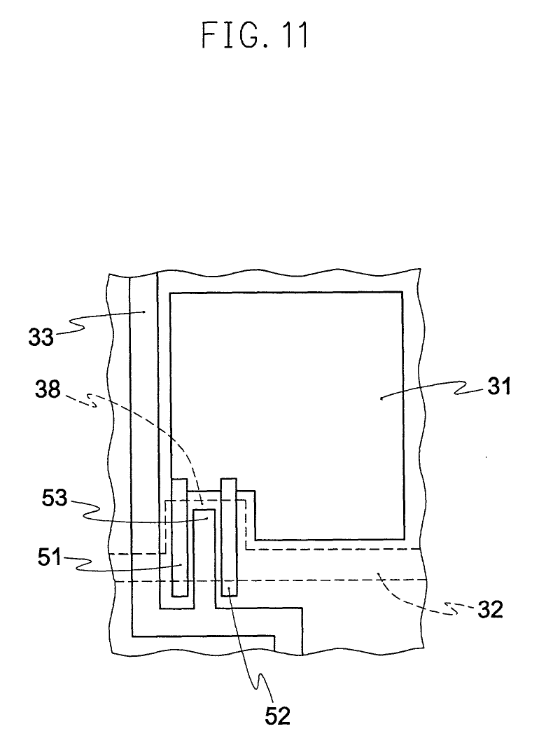

### DETAILED DESCRIPTION

### Embodiment 1

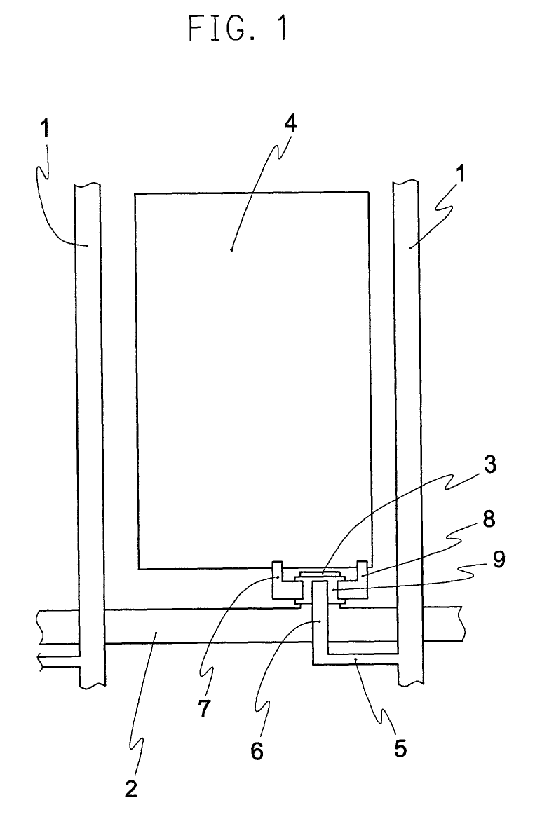

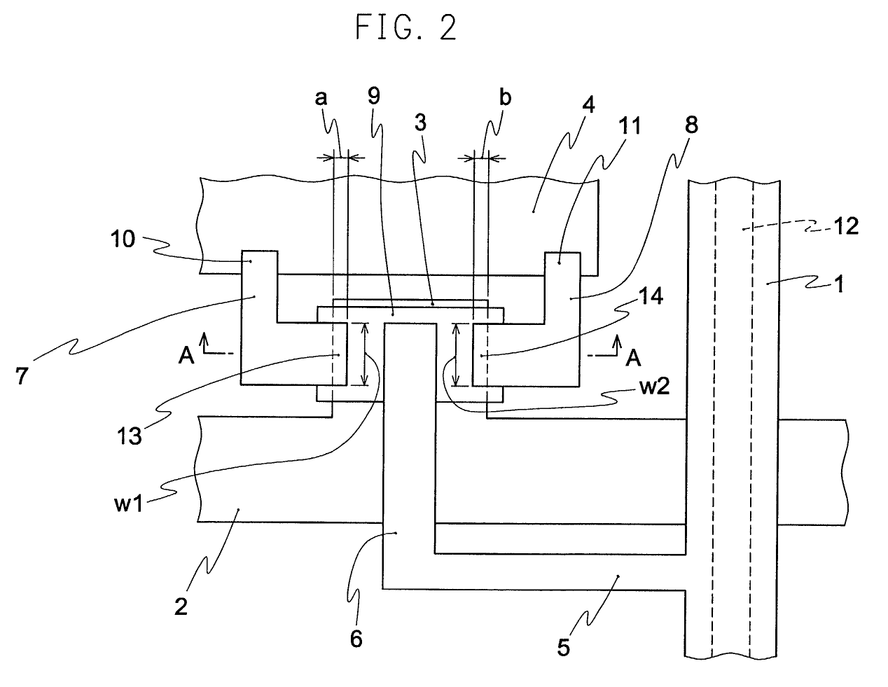

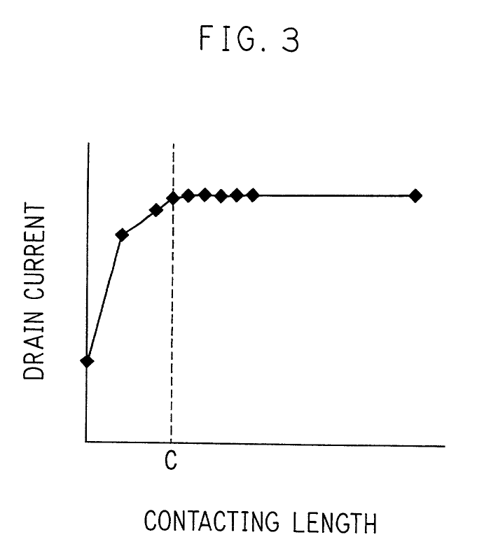

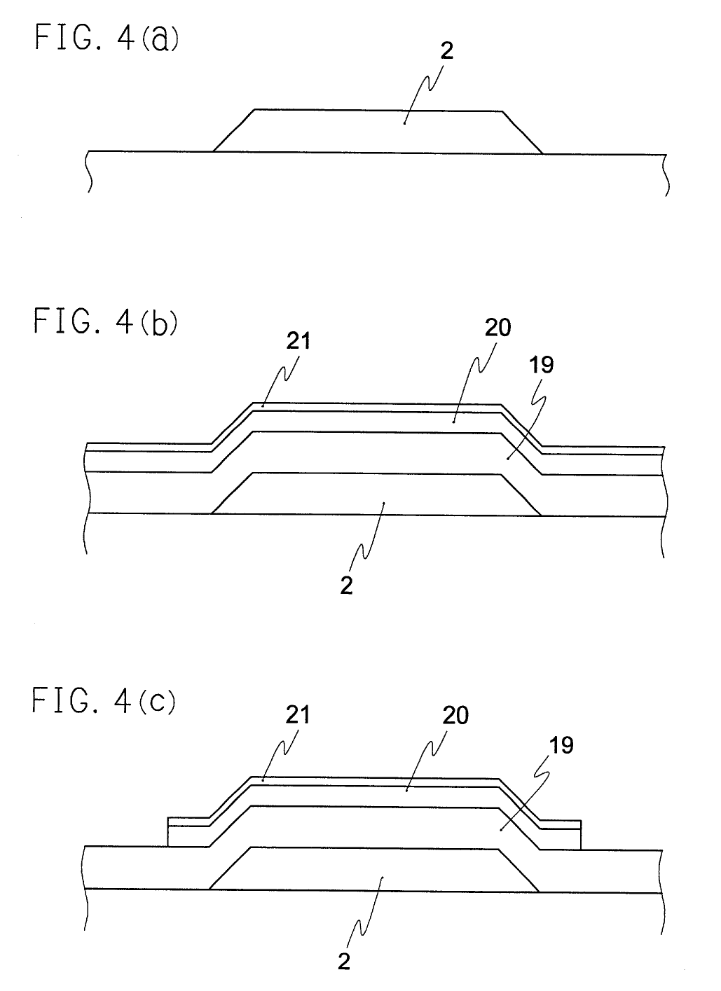

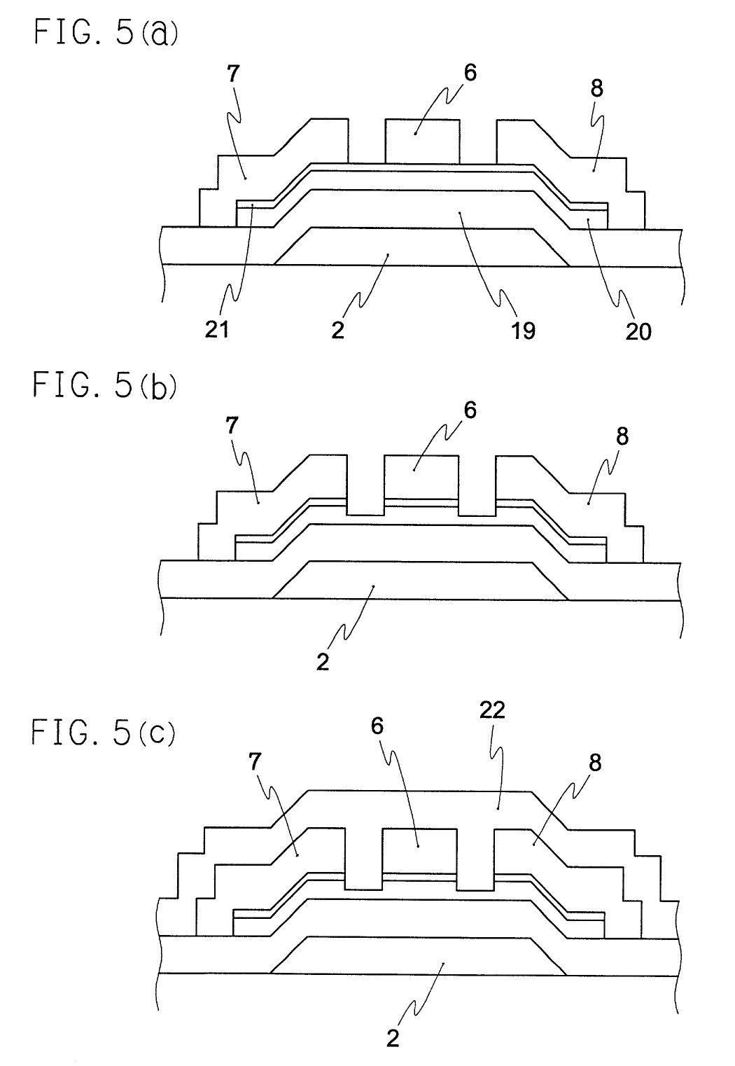

EMBODIMENT 1 of the present invention will be described with reference to FIGS. 1, 2, 3, 4(a) to 4(c), and 5(a) to 5(c). FIG. 1 is a plan view illustrating one pixel of an active matrix type liquid crystal display using a TFT according to EMBODIMENT 1 of the present invention, FIG. 2 is an enlarged view showing a TFT portion illustrated in FIG. 1, FIG. 3 is an explanatory view showing a relation between a drain current and a contact length between a drain electrode and a gate electrode, and FIGS. 4(a) to 4(c) and 5(a) to 5(c) are sectional views taken along a line A-A each illustrating respective manufacturing step. In FIG. 1, the reference numeral 1 denotes a source electrode line, the reference numeral 2 denotes a gate electrode line, the reference numeral 3 denotes a protruding portion of a gate electrode line, the reference numeral 4 denotes a pixel electrode to be a transparent electrode formed of ITO (Indium Tin Oxide) or the like, for example, the reference numeral 5 denotes a lead portion of a source electrode line, the reference numeral 6 denotes a source electrode, the reference numerals 7 and 8 denote first and second drain electrode lines forming first and second TFTs, respectively, and the reference numeral 9 denotes a semiconductor film formed of amorphous silicon or the like, for example.

In FIG. 2, the same components as those in FIG. 1 have the same reference numerals. The reference numeral 10 denotes a connecting portion of the first drain electrode line and the pixel electrode, the reference numeral 11 denotes a connecting portion of the second drain electrode line and the pixel electrode, the reference numeral 12 denotes a semiconductor film formed of amorphous silicon or the like, for example, which is provided under the source electrode line, the reference numeral 13 denotes an overlap portion (a first drain electrode) of the first drain electrode line 7 and the projecting portion 3 of the gate electrode line, the reference numeral 14 denotes an overlap portion (a second drain electrode) of the second drain electrode line 8 and the projecting portion 3 of the gate electrode line, w1 denotes a transistor width (channel width) of the first TFT, w2 denotes a transistor width of the second TFT, “a” denotes a length in a direction of channel length of the first drain electrode (which will be hereinafter referred to as a contact length), and “b” denotes a contact length of the second drain electrode. Also in FIGS. 4 and 5, the same components as those in FIG. 1 have the same reference numerals. The reference numeral 19 denotes a gate insulating film, the reference numeral 20 denotes an intrinsic semiconductor layer, the reference numeral 21 denotes a conductive semiconductor layer into which an n-type impurity, for example, is implanted, and the reference numeral 22 denotes a passivation film. In this specification, the source electrode, the drain electrode and the gate electrode refer to portions of the thin film transistor where a source, a drain and a gate of the transistor are to be formed respectively, and the source electrode line, the drain electrode line and the gate electrode line refer to lines including the source electrode, the drain electrode and the gate electrode respectively.

In FIG. 1, the source electrode line 1 is provided in a vertical direction, the gate electrode line 2 is provided in a horizontal direction, and the pixel electrode 4 is formed in a gap portion formed by the source electrode line and the gate electrode line in a matrics manner.

Furthermore, a lead line portion 5 is formed from the source electrode line in the vicinity of an intersecting portion of the gate electrode line and the source electrode line, and the lead line portion is extended to the source electrode 6. As shown in the enlarged view of FIG. 2, in the TFT portion, the first and second drain electrode lines 7 and 8 are formed to interpose the source electrode 6 therearound in the protruding portion 3 of the gate electrode line, and furthermore, each of the first and second drain electrode lines has one of ends forming each of the first and second drain electrodes 13 and 14 and the other end connected to the same pixel electrode forming one pixel in each of the connecting portions 10 and 11. Furthermore, the protruding portion 3 of the gate electrode line and the first and second drain electrode lines 7 and 8 are formed to have the overlap portions 13 and 14 having equal contact lengths “a” and “b” and an equal area. Moreover, FIGS. 1 and 2 show an example in which the lead portion 5 of the source electrode line is provided outside the gate electrode line in order to reduce Cgd thus a time constant of the gate electrode line.

Thus, the TFT is formed on both sides of the source electrode provided in the vicinity of the center of the protruding portion 3 of the gate electrode line. Therefore, the first and second drain electrodes can be formed with an equal contact length and an equal area of the drain electrode on both sides in the direction of the channel length in the protruding portion of the gate electrode line. Consequently, in the case in which an alignment shift is caused between the layers during the shot, for example, a layer in which the source/drain electrodes are positioned is shifted rightward by ΔX with respect to a layer in which the gate electrode is positioned in FIG. 2, the contact length “a” in the first drain electrode 13 is increased by ΔX but the contact length “b” in the second drain electrode 14 is decreased by ΔX keeping the sum of “a” and “b” constant. Therefore, the parasitic capacitance Cgd (Cgd in one pixel) between the gate electrode and drain electrode in each of the first and second TFTs is not changed. The sum of the area of the first and second drain electrode (overlapping area) 13 and 14 is also kept unchanged. In FIG. 2, moreover, even if source/drain layers are shifted in a vertical direction with respect to a gate layer, the channel width W1 and W2 of the first and second drain electrodes 13 and 14 are provided within the projecting portion 3 of the gate electrode line. Therefore, it is apparent that a difference of Cgd is not made between the shots.

Consequently, even if an alignment shift of each mask is caused between one shot and the other shot, Cgd is not changed between the shots and a luminance unevenness between the shots can be suppressed.

As shown in FIG. 2, furthermore, the present invention is characterized in that each of the first and second drain electrodes forms Cgd by overlapping only the contact length on each end with the gate electrode. As compared with the case in which the conventional drain electrode line intersects the gate electrode line over the whole region in the direction of the channel length which is opposed to the source electrode, the value of Cgd can be reduced in the present invention. As shown in FIG. 3 illustrating the relationship between a drain current and the contact length, if the contact length is equal to or greater than a predetermined length C (for example, approximately 4 μm), a drain current is saturated to have an almost constant current value, and if the contact length is smaller than the predetermined length C, the drain current is reduced. In the present invention, it is preferable that the contact length should be equal to or greater than at least the predetermined length C (such a value as not to reduce the drain current), the value of Cgd greatly depending on an area of contact length X channel width W, the value of Cgd can be reduced without suffering from a reduction of drain current by setting the channel length at a minimum value for avoiding the reduction of the drain current. It is supposed that the value of the predetermined length C is varied depending on the structure or material of the layer. Also in such a case, as shown in FIG. 3, a position in which a drain current characteristic is saturated to be almost constant can be set as the predetermined length C and the contact length can be set to be equal to or greater than at least the predetermined length C.

On the other hand, in the case in which the drain electrode line intersects the gate electrode line over the whole region in the direction of the channel length which is opposed to the source electrode as in the conventional art described above, the value of Cgd increases because the area of drain electrode line width X channel width and the drain electrode width is large. In consideration of stability for film formation, over-etching of a side wall of the drain electrode during patterning and the like, the drain electrode width is set at a marginal large value in many cases. It is apparent from the foregoing that the value of Cgd can be reduced according to the present invention. As described above, the TFT structure of the present invention can reduce the value of Cgd, thereby suppressing the generation of a flicker.

Next, description will be given to a manufacturing flow for fabricating the TFT having a section taken along a line A-A of FIG. 2 with reference to FIGS. 4(a) to 4(c) and 5(a) to 5(c). A conductive film such as aluminum (Al) or chromium (Cr) to be a low resistance metal is formed on an insulating substrate (for example, a glass substrate) by sputtering. Next, a pattern is formed by photolithography and a gate electrode line pattern is formed by etching as shown in FIG. 4(a). Then, a gate insulating film 19 formed of a nitride film or the like, for example, an intrinsic semiconductor layer 20 formed of amorphous silicon to be a channel, for example, and a conductive semiconductor layer 21 formed of amorphous silicon which is doped with an n-type impurity, for example, are continuously formed by plasma CVD (Chemical Vapor Deposition), for example, as shown in FIG. 4(b).

Subsequently, the photolithography is carried out as shown in FIG. 4(c) to etch the semiconductor layer. Next, a conductive film such as aluminum (Al) or chromium (Cr) to be a source/drain electrode is deposited by sputtering. As shown in FIG. 5(a), then, the source/drain electrode is subjected to patterning by the photolithography. As shown in FIG. 2, the source and drain electrodes are subjected to the patterning such that each end of the two drain electrode lines forms a drain electrode respectively in an overlap portion with the gate electrode end in a part of a direction of a channel length which is opposed to the source electrode, and the other ends of the drain electrode lines are connected to the pixel electrode. Moreover, when the etching is to be carried out, a very small amount of chromium silicide (CrSix) is formed, for example, by reaction of the semiconductor layer such as amorphous silicon to a metal film such as Cr so that a short-circuit might be formed between the source and drain electrode. Therefore, a channel region is isolated by removal of CrSix and the conductive semiconductor layer as shown in FIG. 5(b), and furthermore, the intrinsic semiconductor layer is subjected to the etching and is etched down. As shown in FIG. 5(c), furthermore, a passivation film 22 formed of a nitride film or the like, for example, is deposited by plasma CVD, for example. Thus, the TFT is completed.

While a reverse stagger type (bottom gate type) TFT structure is illustrated in FIGS. 4(a) to 4(c) and 5(a) to 5(c), the present invention may be applied to a so-called forward stagger type (top gate type) TFT structure in which a gate electrode is provided on a source/drain electrode. Furthermore, a layer structure shown in FIGS. 4(a) to 4(c) and 5(a) to 5(c) is not restricted but the present invention can be applied to all the cases in which the TFT is formed on an insulating substrate.

### Embodiment 2

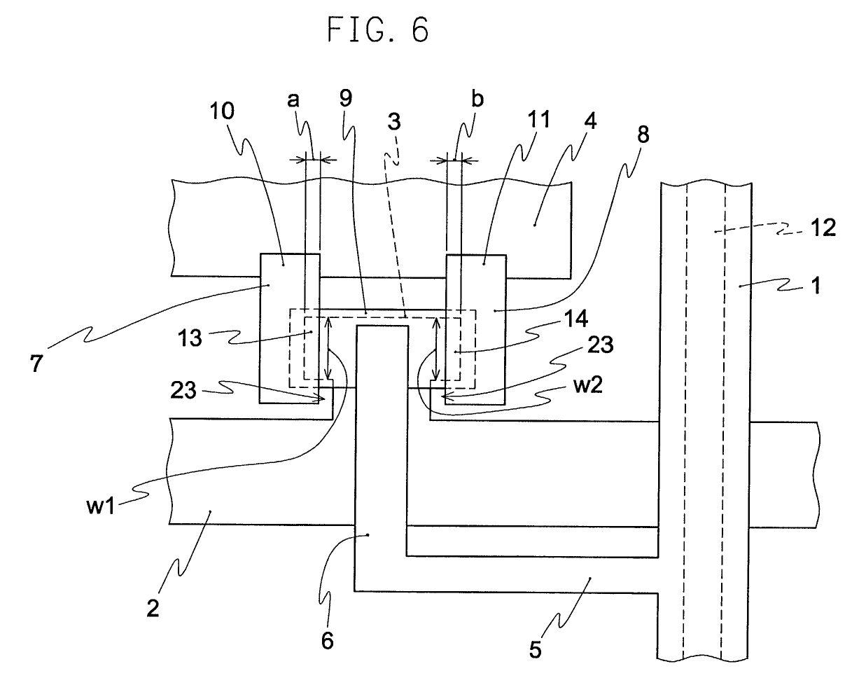

EMBODIMENT 2 of the present invention will be described with reference to FIG. 6. FIG. 6 is an enlarged view showing a TFT portion according to EMBODIMENT 2 of the present invention. In FIG. 6, the same components as those in FIGS. 1 and 2 have the same reference numerals and differences from FIG. 2 will be described. In FIG. 6, each of first and second drain electrode lines 7 and 8 has one of ends connected to the same pixel electrode 4 forming one pixel through each of connecting portions 10 and 11 and the other portion forming each of drain electrodes 13 and 14 by overlapping only a part in a direction of a channel length opposed to a source electrode with a protruding portion 3 of the gate electrode line. In the projecting portion 3 of the gate electrode line, a notch portion 23 is formed in the vicinity of portions where the first and second drain electrodes 13 and 14 are formed, and therefore overlapping portions W1, W2 between the drain electrodes and the gate electrode are reduced thus reducing the value of Cgd.

With the above-mentioned structure, the following is apparent. More specifically, even if an alignment shift is caused between the layers during the shot, a difference of Cgd between the shots is not made on a shift in a horizontal direction for the same reason as that of EMBODIMENT 1 and on a shift in a vertical direction because portions of each of the drain electrode lines 7 and 8 forming drain electrodes 13 and 14 are provided on the gate electrode which width W1 and W2 are restricted by the notch portion 23.

As described above, at the portions of each of the first and second drain electrode lines, only a part in the direction of the channel length opposed to the source electrode is overlapped with the projecting portion of the gate electrode line to form each of the drain electrodes 13 and 14. However, by setting the channel length in the drain electrode line which is opposed to the source electrode to have at least such a value as not to reduce the drain current of the thin film transistor, therefore, the value of Cgd can be reduced to suppress a flicker without reducing the drain current in the same manner as in EMBODIMENT 1.

As is apparent from FIG. 6, furthermore, only a part in the direction of the channel width in the portion of the first and second drain electrode lines which is opposed to the source electrode acts as a drain electrode. Therefore, a portion of an area occupied by the drain electrode lines is reduced and an aperture ratio can be enhanced.

While the example in which the end width of the projecting portion of the gate electrode line in the direction of a channel width is provided on the inside of the end of the semiconductor film in the same direction has been described in the present embodiment as shown in FIG. 6, the end of the gate electrode line in the direction of the channel width may be provided on the outside of the end of the semiconductor film in the same direction as shown in FIG. 2 illustrating EMBODIMENT 1.

As described above, in the present embodiment, even if the alignment shift of each mask is caused during shots, Cgd is not changed between the shots, a shot unevenness can be suppressed, and furthermore, a reduction in the value of Cgd can suppress the generation of a flicker, thus a high display quality and an enhancement of the aperture ratio can be obtained in the same manner as in the first embodiment.

### Embodiment 3

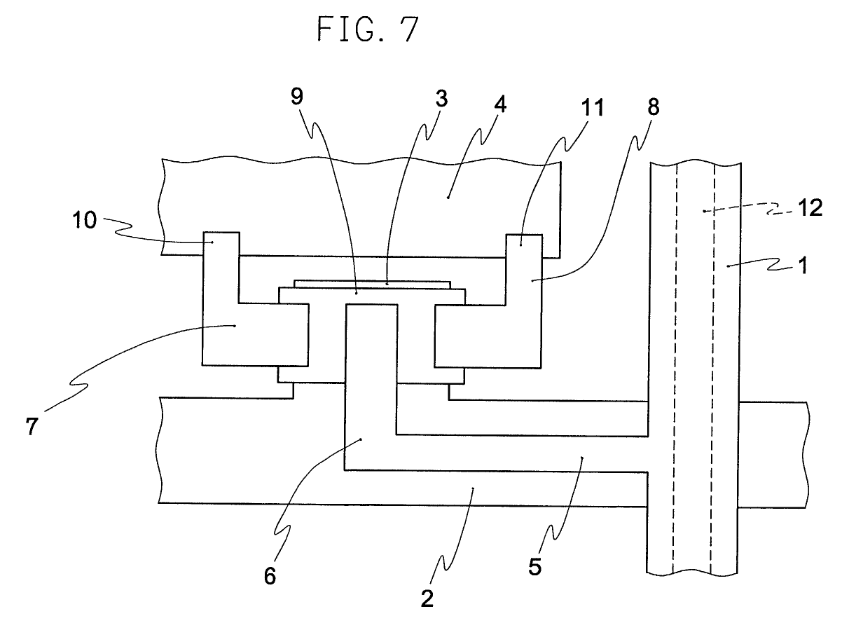

EMBODIMENT 3 of the present invention will be described with reference to FIG. 7. FIG. 7 is an enlarged view showing a TFT portion according to EMBODIMENT 3 of the present invention. In FIG. 7, the same components as those in FIGS. 1 and 2 have the same reference numerals and differences from FIG. 2 will be described. In FIG. 7, a lead portion 5 of a source electrode line is provided on a gate electrode line 2 through an insulating film.

With the above-mentioned structure, the same effects as those in EMBODIMENT 1 can be obtained. In addition, since the lead portion of the source electrode line which is an opaque metal film is not provided in a light transmitting aperture but on the gate electrode line. Therefore, an aperture ratio can be enhanced.

While the case in which the source electrode line is provided on the gate electrode line has been described in the present embodiment, the same effects can be obtained also in the case in which the gate electrode line is provided on the source electrode line by provision of the lead portion of the source electrode line under the gate electrode line.

### Embodiment 4

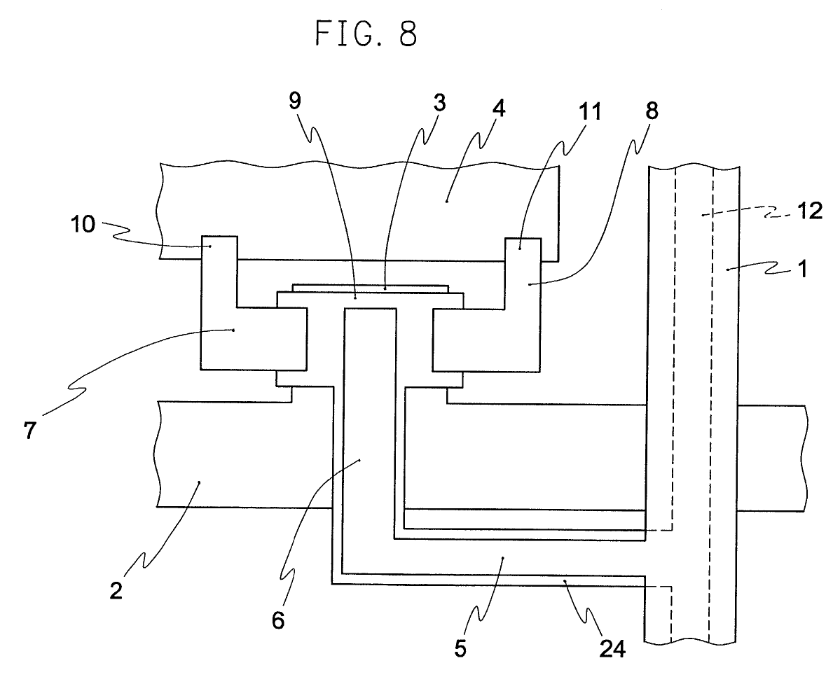

EMBODIMENT 4 of the present invention will be described with reference to FIG. 8. FIG. 8 is an enlarged view showing a TFT portion according to EMBODIMENT 4 of the present invention. In FIG. 8, the same components as those in FIGS. 1 and 2 have the same reference numerals and differences from FIG. 2 will be described. In FIG. 8, a semiconductor film 24 is provided under a lead portions 5 of the source electrode 6 continuously from a semiconductor film 9 under the source electrodes to a semiconductor film 12 under the source electrode line 1.

With the above-mentioned structure, the same effects as those in EMBODIMENT 1 can be obtained. In an intersecting portion of the gate electrode line with the source electrode line, furthermore, a step difference due to the thickness of the gate electrode line is relieved depending on a thickness of a semiconductor film to suppress a disconnection of the source electrode line. Consequently, manufacturing yield can be enhanced.

While the case in which the source electrode line is provided on the semiconductor film in the present embodiment, it is also possible in the case in which the semiconductor film is provided on the source electrode line to relieve a step difference due to the thickness of the source electrode line depending on the thickness of the semiconductor film to suppress the disconnection of the gate electrode line through the provision of the semiconductor film on the lead portion 5 of the source electrode line. Consequently, the manufacturing yield can be enhanced.

### Embodiment 5

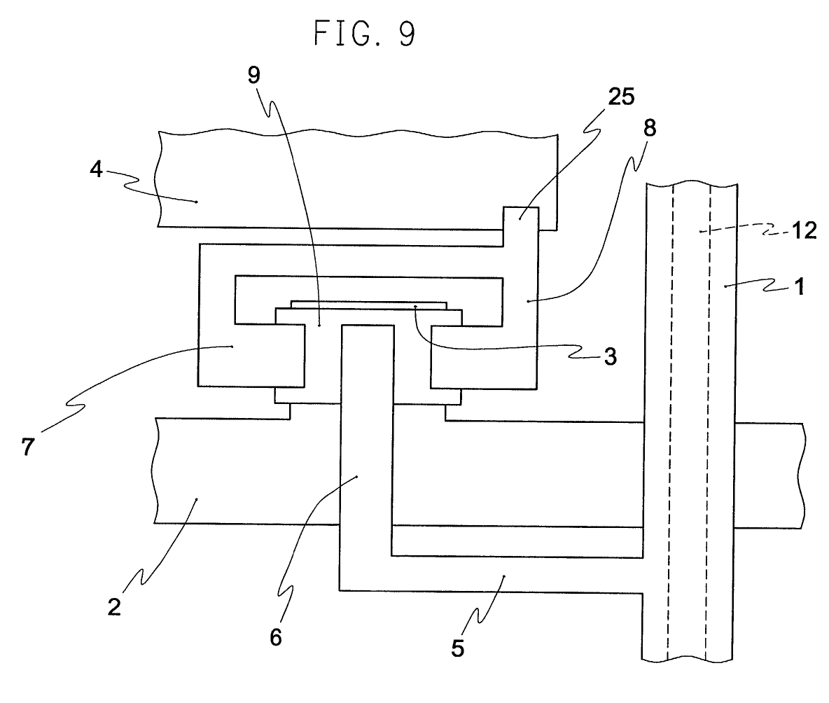

EMBODIMENT 5 of the present invention will be described with reference to FIG. 9. FIG. 9 is an enlarged view showing a TFT portion according to EMBODIMENT 5 of the present invention. In FIG. 9, the same components as those in FIGS. 1 and 2 have the same reference numerals and differences from FIG. 2 will be described. In FIG. 9, first and second drain electrode lines are connected in common through a connection between a TFT and a pixel electrode, and are connected to a pixel electrode 4 in only one connecting portion 25.

With the above-mentioned structure, the same effects as those in EMBODIMENT 1 can be obtained. In addition, the drain electrode line and the pixel electrode are connected in one portion so that an aperture ratio can be enhanced.

### Embodiment 6

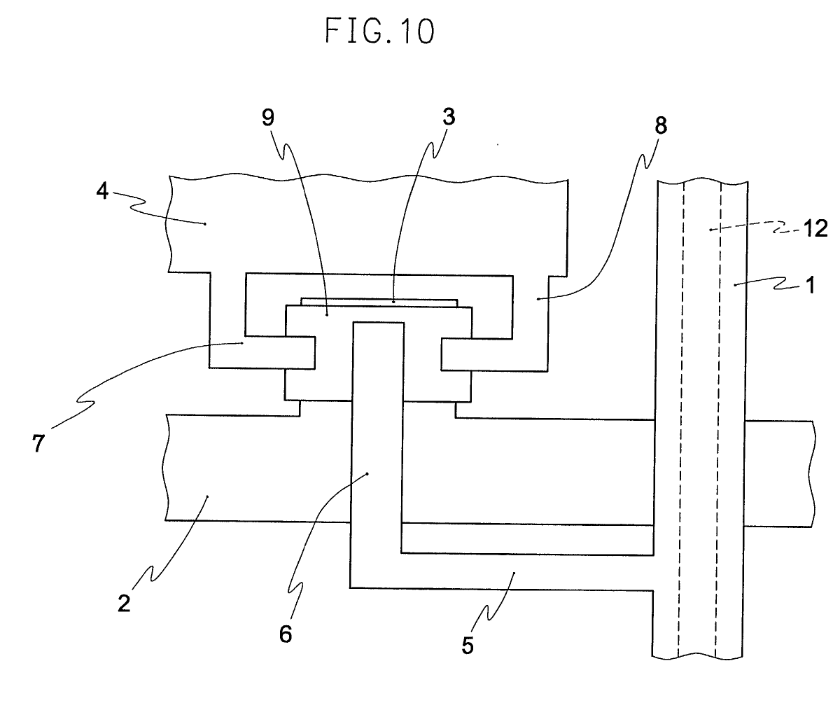

EMBODIMENT 6 of the present invention will be described with reference to FIG. 10. FIG. 10 is an enlarged view showing a TFT portion according to EMBODIMENT 6 of the present invention. In FIG. 10, the same components as those in FIGS. 1 and 2 have the same reference numerals and differences from FIG. 2 will be described. FIG. 10 shows an example in which the same transparent electrode film as a pixel electrode is used for a drain electrode line and a drain electrode.

With the above-mentioned structure, the same effects as those in EMBODIMENT 1 can be obtained. In addition, a connecting portion of the drain electrode line and the pixel electrode is not required. Consequently, an aperture ratio can be enhanced.

While other examples in EMBODIMENT 1 have been described in EMBODIMENT 3 to EMBODIMENT 6, it is apparent that the same effects can be obtained by the application of EMBODIMENT 3 to EMBODIMENT 6 to the structure according to EMBDIMENT 2. Furthermore, even if EMBODIMENT 3 to EMBODIMENT 6 are properly combined for application to the structures according to EMBODIMENT 1 and EMBODIMENT 2, respective effects can be obtained.

While the case in which one TFT is formed on each side interposing the source electrode has been described in EMBODIMENT 1 to EMBODIMENT 6, one or more TFTs may be used on each of both sides. Also in that case, it is preferable that the sum of the areas of the overlap portions of the respective drain electrode lines on both sides and the sum of contact length should be unchanged in spite of the shot position shift. Furthermore, although the areas of the overlap portions of the respective drain electrode lines on both sides of the source electrode and the contact length on both side are equal in the first to sixth embodiments, it is apparent that the same effects can be obtained if they are substantially equal with a difference in such a range as not to make problems in respect of display characteristics. Moreover, although the case in which one source electrode is formed has been described in EMBODIMENT 1 to EMBODIMENT 6, it is a matter of course that a common structure has no problem even if a plurality of source electrodes are formed.

While the TFT structure of the liquid crystal display has been described in EMBODIMENT 1 to EMBODIMENT 6, furthermore, the present invention is not restricted to a display device using a liquid crystal but can be applied to any active matrix type display device using an electroluminescent element or the like.

While the example in which the end of the gate electrode line in the direction of the channel width is provided on the outside of the end of the semiconductor film in the same direction has been described in EMBODIMENT 1 and EMBODIMENT 3 to EMBODIMENT 6, the end of the gate electrode line in the direction of the channel width may be provided on the inside of the end of the semiconductor film in the same direction as described in EMBODIMENT 2.

According to the first aspect of the present invention, a display device comprises a thin film transistor formed on an insulating substrate, wherein a plurality of thin film transistors are formed for one pixel, the thin film transistors having a source electrode line including a source electrode, interposing the source electrode therebetween and having at least one drain electrode line on both sides respectively, the respective drain electrode lines forming a drain electrode in an overlap portion with the gate electrode line in a part in a direction of a channel length which is opposed to the source electrode and the other end of the drain electrode line being connected to a pixel electrode. Therefore, a flicker can be prevented so that a high display quality can be obtained.

According to the second aspect of the present invention, the display device according to the first aspect of the present invention is characterized in that sums of areas of the respective overlap portions on both sides of the source electrode are substantially equal to each other. Therefore, a flicker can be prevented so that a high display quality can be obtained.

According to the third aspect of the present invention, the display device according to the second aspect of the present invention is characterized in that lengths in the direction of the channel length of the thin film transistor in the respective overlap portions on both sides of the source electrode are substantially equal to each other. Therefore, a shot unevenness, as well as a flicker, can be prevented so that a high display quality can be obtained.

According to the fourth aspect of the present invention, the display device according to the third aspect of the present invention is characterized in that the length in the direction of the channel length of the thin film transistor in the overlap portion is a predetermined length which does not reduce a current characteristic of the thin film transistor. By further reducing Cgd, therefore, a flicker can be prevented, and furthermore, a shot unevenness can be suppressed so that a high display quality can be obtained.

According to the fifth aspect of the present invention, the display device according to the first, second, third or fourth aspect of the present invention is characterized in that the drain electrode is formed in the overlap portion with the gate electrode line over a whole region in a direction of a drain electrode line width on one of ends of the drain electrode line. Therefore, a flicker can be prevented so that a high display quality can be obtained.

According to the sixth aspect of the present invention, the display device according to the first, second, third or fourth aspect of the present invention is characterized in that the drain electrode is formed in the overlap portion with the gate electrode line in a part in the direction of the drain electrode line width excluding an end in the vicinity of one of ends of the drain electrode line, and one of the ends of the drain electrode line is provided outside the gate electrode line. A flicker can be prevented, and furthermore, an aperture ratio can be enhanced.

According to the seventh aspect of the present invention, the display device according to the first, second, third, fourth, fifth or sixth aspect of the present invention is characterized in that a source electrode line to be led from the source electrode line to the source electrode is provided through an insulating film above or under the gate electrode line with respect to the insulating substrate. Therefore, a flicker can be prevented in addition to the suppression of a shot unevenness, and furthermore, an aperture ratio can be enhanced.

According to the eighth aspect of the present invention, the display device according to the first, second, third, fourth, fifth, six or seventh aspect of the present invention is characterized in that a semiconductor film is formed under or above the source electrode line to be led from the source electrode line to the source electrode with respect to the insulating substrate. Therefore, a flicker can be prevented, and furthermore, the source electrode line or the gate electrode line can also be prevented from being disconnected.

According to the ninth aspect of the present invention, the display device according to the first, second, third, fourth, fifth, sixth, seventh or eighth aspect of the present invention is characterized in that at least one drain electrode line provided on both sides of the source electrode respectively is connected between the thin film transistor and a pixel electrode and is connected to the pixel electrode in only one portion. Therefore, a flicker can be prevented, and furthermore, an aperture ratio can be enhanced.

According to the tenth aspect of the present invention, the display device according to the first, second, third, fourth, fifth, sixth, seventh, eighth or ninth aspect of the present invention is characterized in that the drain electrode line is formed of the same film as the pixel electrode. Therefore, a flicker can be prevented and, and furthermore, an aperture ratio can be enhanced.

The present invention is characterized by a method of manufacturing the first display device comprising the steps of forming a gate electrode pattern on an insulating substrate, forming an insulating film covering the gate electrode, forming a semiconductor film on the insulating film, depositing a conductive film to be a source/drain electrode on the semiconductor film, and patterning the deposited conductive film such that the source electrode is interposed, at least one drain electrode line is provided on both sides respectively, the respective drain electrode lines form a drain electrode in an overlap portion with a gate electrode line in a part in a direction of a channel length which is opposed to the source electrode, and the other end of the drain electrode line is connected to a pixel electrode. Therefore, a flicker can be prevented so that a display device having a high display quality can be obtained.

The present invention is characterized by a method of manufacturing the second display device comprising the steps of depositing a conductive film to be a source/drain electrode on an insulating substrate, patterning the deposited conductive film such that the source electrode is interposed, at least one drain electrode line is provided on both sides respectively, the respective drain electrode lines form a drain electrode in an overlap portion with a gate electrode line in a part in a direction of a channel length which is opposed to the source electrode, and the other end of the drain electrode line is connected to a pixel electrode, forming a semiconductor film on the source/drain electrode, forming an insulating film covering the semiconductor film, and forming a gate electrode pattern on the insulating film. Therefore, a flicker can be prevented so that a display device having a high display quality can be obtained.

The present invention is characterized by the method of manufacturing the third display device according to the first or second aspect of the present invention, further comprising the step of forming a pixel electrode pattern to be connected to the drain electrode line, the drain electrode line being formed at the same step as the step of forming the pixel electrode pattern. Therefore, a flicker can be prevented, and furthermore, an aperture ratio can be enhanced.

The forgoing is considered as illustrative only of the principles of the invention. Further, because numerous modifications and changes will readily occur to those skilled in the art, it is not desired to limit the invention to the exact construction and operation shown and described, and accordingly all suitable modifications and equivalents may be resorted to falling within the scope of the invention as definition by the claims which follow.

What is claimed is:

1. A liquid crystal display comprising:
a gate electrode line including a gate electrode formed on an insulating substrate;
a source electrode line including a source electrode intersected with said gate electrode line via an insulating film;
a thin film transistor located in a vicinity of a portion in which said gate electrode line is intersected with said source electrode line;
two drain electrode lines, each including two drain electrodes in said thin film transistor, said drain electrode line being connected with a pixel electrode;
wherein said thin film transistor includes said two drain electrode lines located on both sides of said source electrode; said two drain electrodes are formed at a place where each end portion of said two drain electrode lines opposed to said source electrode is superposed with said gate electrode line.

2. The liquid crystal display of claim 1, wherein an area of a region where said gate electrode line is superposed with one of said two drain electrode lines is substantially identical to an area of a region where said gate line is superposed with the other one of said two drain electrode lines.

3. The liquid crystal display of claim 2, wherein a length of a region in a channel lengthwise direction of said thin film transistor where said gate electrode line is superposed with one of said two drain electrodes is substantially identical to a length of a region in a channel lengthwise direction of said thin film transistor where said gate electrode line is superposed with the other one of said two drain electrode lines.

4. The liquid crystal display of claim 3, wherein said length of said area in the channel lengthwise direction is such a length as to prevent a current characteristics from degradation in said thin film transistor.

5. The liquid crystal display of any one of claims 1, 2, 3 and 4, wherein said drain electrode is formed in whole part of one end of said drain electrode line in a channel widthwise direction where said drain electrode line is superposed with said gate electrode line.

6. The liquid crystal display of any one of claims 1, 2, 3 and 4, wherein said drain electrode is formed at a portion where a part of one end of said drain electrode line in the channel widthwise direction opposed to said source electrode is superposed with said gate electrode line on both sides of said source electrode.

7. The liquid crystal display of any one of claims 1, 2, 3, 4, 5 and 6, wherein a lead portion of said source electrode line extended to said source electrode from said source electrode line is provided with a semiconductor film situated above or below said gate electrode line via an insulating film in reference to the insulating substrate.

8. The liquid crystal display of any one of claims 1, 2, 3, 4, 5, and 7, wherein a lead portion of said source electrode line extended to said source electrode from said source electrode line is provided with a semiconductor film, said semiconductor film being situated above said lead portion of said source electrode line or below the same in reference to the insulating substrate.

9. The liquid crystal display of claims 1, 2, 3, 4, 5, 6, 7 or 8, wherein said two drain electrodes opposed to said source electrode on both sides of said source electrode are connected with each other in the region between said two drain electrode lines and said pixel electrode, said drain electrodes being connected with said pixel electrode by a single part of said drain electrodes.

10. The liquid crystal display of claims 1, 2, 3, 4, 5, 6, 7, 8 or 9, wherein said drain electrode line is formed of a same film as that of said pixel electrode.

11. A method for manufacturing a liquid crystal display comprising steps of:
forming a gate electrode line pattern on an insulating substrate;
forming a semiconductor film covering said gate electrode line;
depositing a conductive film serving as source/drain electrodes on said insulating film; and
subjecting said deposited conductive film to patterning in such a manner that two drain electrodes are formed in a portion where each end of two drain electrodes opposed to said source electrode is superposed in a channel lengthwise direction with said gate electrode line on both sides of said source electrode.

12. A method for manufacturing a liquid crystal display comprising steps of:
depositing a conductive film on an insulating substrate serving as source/drain electrodes;
subjecting said deposited conductive film to patterning in such a manner that two drain electrodes are formed in a portion where each part of the two drain electrode lines extending in a channel lengthwise direction is superposed with a gate electrode line, said drain electrode lines being opposed to said source electrode on both side surfaces;
forming a semiconductor film on said source/drain electrodes;
forming an insulating film in such a manner as to cover said semiconductor film; and
forming a gate electrode pattern on said insulating film.

13. The method of claim 11 or 12, further comprising a step of forming a pixel electrode pattern connected with said drain electrode, wherein said drain electrode is formed in said step of forming said pixel electrode pattern.
